(19) United States
(12) Patent Application Publication
(10) Pub. No.: US 2008/0012872 A1
(43) Pub. Date: Jan. 17, 2008

(54) System for Real-time Processing Changes Between Video Content in Disparate Formats

(76) Inventors: Jon M. Flickinger JR., Topeka, KS (US); Cary Shoup, Topeka, KS (US); Gary Hammes, Topeka, KS (US)

Correspondence Address: BROMBERG & SUNSTEIN LLP, 125 SUMMER STREET, BOSTON, MA, 02110-1618, US

(21) Appl. No.: 11/754,069

(22) Filed: May 25, 2007

Related U.S. Application Data
(60) Provisional application No. 60/808,291, filed on May 25, 2006.

(51) Int. Cl. G06T 1/20

(52) U.S. Cl. 345/581

(57) ABSTRACT

A modular video processing system and methodology for processing a plurality of video assets having different asset properties in real-time to a common format compatible with a display device is described. The system includes a plurality of pipelined video processing modules wherein each operational pipelined video processing module performs a different configurable video processing function on one or more video asset frames. The system also includes a process control module for providing each operational pipelined video processing module with data for configuring the video processing module for a current frame and data for configuring the video processing module for a subsequent frame wherein each configuration is based on one or more asset properties for the video asset being processed. Each pipelined video processing module has a memory location for the configuration for the current frame and a memory location for the configuration for a subsequent frame.

### PRIORITY

The present patent application claims priority form U.S. provisional patent application Ser. No. 60/808,291 filed on May 25, 2006 entitled System for Real-time Processing Changes between Video Content in Disparate Formats which is incorporated herein by reference in its entirety.

### TECHNICAL FIELD AND BACKGROUND ART

The present invention relates to video processing and more specifically to real-time processing of video content in disparate formats.

It is known in the prior art to splice together film from different sources to make a film product that will seamlessly transition between the two sources during playback on a projector. However, the two sources must share the same geometry (i.e. have the same film size, 35 mm, 70 mm etc.).

In the digital domain, video sources, known as video assets, often have different asset properties, for example, geometries (e.g. 1920×1080, 1280×720, 2048×1080, 4096×2160), scanning type (progressive, interlaced), aspect ratios, such as 4:3 or 16:9, encoding formats (e.g. JPEG2000, MPEG-2, MPEG-4, QuVIS), encryption types, and decryption key requirements. Typically, projectors in the digital cinema area support a single geometry and aspect ratio. Some newer projectors support multiple formats (geometries and aspect ratios); however the projectors are not capable of switching between different geometries and aspect ratios without disruption to the displayed images. Therefore, sources that are to be shown in succession (e.g. commercials followed by a feature film) must be conformed to the requirements of the projector. As a result, in order to conform the video source material to the projector's requirements, prior art systems have processed the digital data from one or more similar assets individually through a processor(s). After the assets of the first type are completely processed, assets of a second type may be processed by providing the asset properties for the second asset to the processor(s). Thus, during presentation of the disparate video sources, there is a delay between each of the sources while the processor(s) completes processing of the digital data based on the asset properties for that source.

### SUMMARY OF THE INVENTION

In a first embodiment of the invention there is provided a modular video processing system capable of processing a plurality of video assets having different asset properties in real-time for display on a display device, such as a projector. In one embodiment, the modular video processing system is under centralized control that provides timing information to each module along with the asset properties for the current frame and the next frame. Thus, if a module is currently processing the final frame from asset A and the next frame is the first frame from asset B, the module already contains in a memory location the configuration for asset B, so that the module may seamlessly process the frame from asset B. As a result, the processing occurs in real-time and the assets can be displayed on a projector without a noticeable pause between assets.

The modular video processing system may include a plurality of pipelined video processing modules wherein each operational pipelined video processing module performs a different configurable video processing function on one or more video asset frames. The system may also include a process control module for providing each operational pipelined video processing module with data for configuring the video processing module for a current frame and data for configuring the video processing module for a subsequent frame wherein each configuration is based on one or more asset properties for the video asset being processed. In one embodiment, each pipelined video processing module has a memory location for the configuration for the current frame and a memory location for the configuration for a subsequent frame and the pipelined video processor switches between the memory location for the configuration for the current frame and the memory location for the subsequent frame based on a timing signal. In another embodiment, the process control module calculates one or more operating parameters of the configuration based on the one or more asset properties of the video asset. In other embodiments, video asset parameters are provided to each of the processing modules and the processing modules determine their operating parameters.

In some embodiments, the processing modules each operate on a different frame of video and complete processing of the frame within a frame period. In other embodiments, processing modules may run in parallel and operate over a number of frame periods. In such systems, the output is that of the display rate.

The process control module may include a plurality of modules that operate hierarchically. There can be a high level centralized process control module that operates globally between process modules communicating over a bus and then localized process control that is shared by one or more processing modules. If the localized process control is shared by more than one processing module, information may be fed forward between processing modules that are used in determining configuration data.

The pipelined processing modules can be either operational or non-operational during the processing of a video asset. For example, a video asset may or may not be encrypted and therefore, the decryption processing module can be bypassed if the asset is not encrypted.

Video assets having different asset properties can be processed in substantially real-time to a format compatible with a display device using the systems and methods described. In one configuration, a play list of the plurality of video assets to be displayed on a display device is obtained. The video processing system sequentially retrieves each video asset listed in the play list from a memory location. Each video asset is processed sequentially to a format that is compatible with the display device and the processed sequential video assets are output to the display device.

### BRIEF DESCRIPTION OF THE DRAWINGS

The foregoing features of the invention will be more readily understood by reference to the following detailed description, taken with reference to the accompanying drawings, in which:

FIG. 1 is a block diagram showing a server that receives video assets from different sources, processes the video assets in real-time and provides the processed video assets to a projector for display;

FIG. 2 is a block diagram of a display showing different asset properties for different assets based upon frame geometries and aspect ratios;

FIG. 3 is a block diagram of a modular video processing system with a central process control for processing assets with different properties through a pipeline in real-time;

FIG. 4 is a block diagram of a typical processing module from FIG. 3;

FIG. 4A shows a detailed timing diagram showing the operation of the process control module during the middle of frame switching between a current frame configuration register and a next frame configuration register for an exemplary processing module;

FIG. 5 shows a flow chart explaining an alternative embodiment for updating the current frame and next frame configuration registers;

FIG. 6 is a timing diagram that shows the progression of both the encoded frame data through the decoding system and the progression of the configuration information/operating parameters for each of the modules;

FIGS. 7A and 7B show a different processing pipeline and corresponding timing diagram from that shown in FIG. 6; and

FIG. 8 shows an example of a plurality of pipelined processing stages wherein the stages feed forward information that is used by the process control internal to subsequent modules for determining the configuration parameters for the subsequent modules for a video asset.

### DETAILED DESCRIPTION OF SPECIFIC EMBODIMENTS

Definitions: As used in the following detailed description and the claims the term “real-time” in relation to the video processing system indicates that the video processing system outputs video frame data substantially at a display rate for a display device. For example, if the display rate is 24 frames per second, the video processing system would typically decode the video and output 24 frames per second. Thus, if there are two disparate video assets that the system is processing sequentially, the system would output displayable frame data so that the output would appear continuous without pause to an audience. This system contemplates the ability to insert transitions between video assets. In such an embodiment, a transition to black would be considered a separate video asset. A real-time system may have latency between input and output; however the output substantially conforms to the display rate.

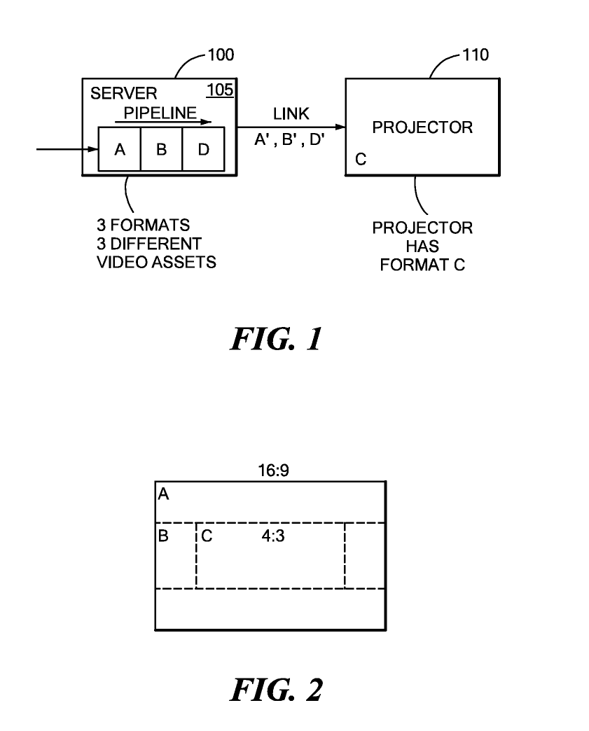

FIG. 1 is a block diagram showing a server 100 that receives video assets (A,B,D,) from different sources, processes the video assets in real-time in a processing pipeline 105, and provides the processed video assets (A′, B′, D′) to a projector 110 for display. As shown, the server 100 receives in three video assets. Each asset has associated asset properties. The asset properties can include, for example, geometry (frame size), color space, encoding, encryption, key placement, and temporal display of data (interlaced/progressive). For example, the first asset (video asset A) may be a feature film and the second (video asset B) and thirds assets (video asset D) may be local and regional advertisements that are to be played prior to display of the feature film. The feature film may be provided to the server from a different source than each of the advertisements. Additionally, the three assets can have different asset properties.

Although three assets are shown, two or more assets may be processed in real-time without deviating from the scope of the invention.

The data is processed in a system to conform the assets to the properties of the projector (Format C). For example, the projector may have a predetermined geometry and aspect ratio. As each of the video assets is processed through the system in a pipelined manner, so that there are no temporal gaps in the output and the projector seamlessly displays the assets without pausing between the display of the assets.

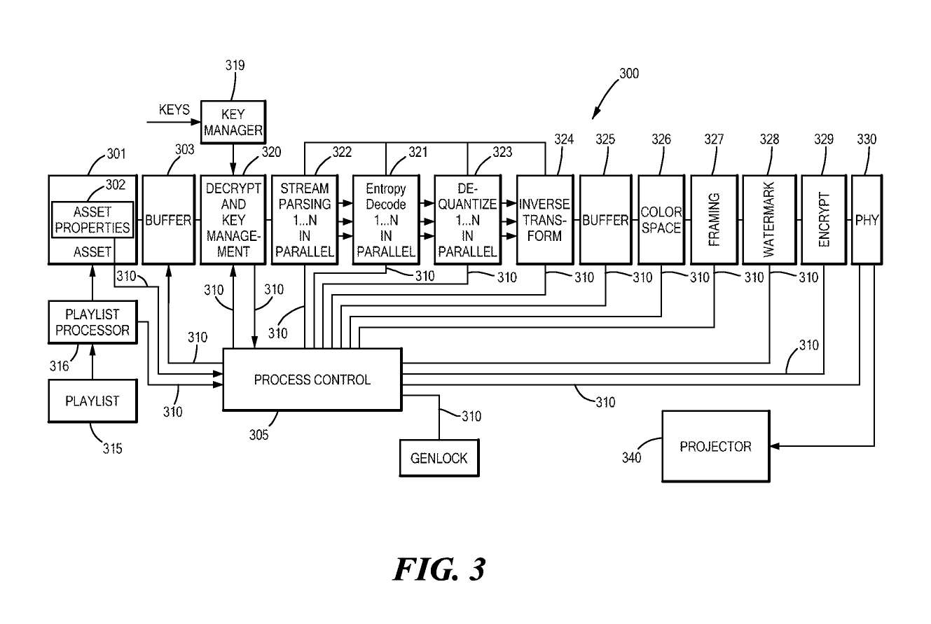

FIG. 2 is a block diagram of a display showing different asset properties for different assets based upon frame geometries and aspect ratios. As such, video asset A is the largest geometric asset and fully fills the 16:9 screen. Video asset B is also a 16:9 asset, but has fewer pixels vertically. Video asset C contains the fewest pixels and is in a 4:3 aspect ratio. Thus, each of the three assets has different asset properties and the properties need to be conformed for display on a display device or projector.

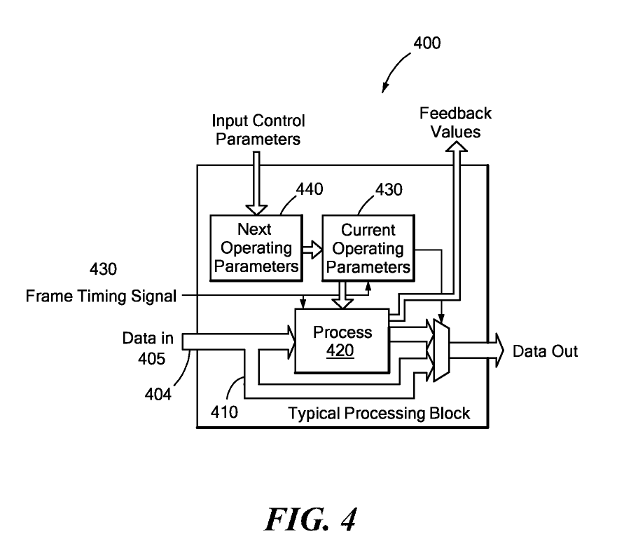

FIG. 3 is a block diagram of a modular video processing system 300 with a central process control module for processing video assets 301 with different asset properties 302 through a pipeline in real-time. The video processing system 300 may be part of the server as shown in FIG. 1. The process control module 305 couples to each of the processing modules through a microprocessor bus 310. As shown in FIG. 3 the bus 310 is represented by a each of the connections between the process control module 305 and the individual processing modules. Attributes that describe the video assets being processed are used by the process control module 305 to effect changes at each processing block at the appropriate time for the pipelined data. These attributes partly come from the video assets in memory, and partly from a decryption module 320 which extracts them from encrypted material.

As shown, a playlist 315 is provided to a playlist processor 316. The playlist processor 316 retrieves assets 301 listed in the playlist 315 along with the asset properties 302 from memory and places the assets 301 into a buffer 303 in the proper order for presentation. The playlist processor 316 provides this information to the process control module 305. The process control module 305 receives the playlist order 315 and also receives the asset properties 302. The asset properties 302 may be directed through the playlist processor 316 or sent directly to the process control module 305. Additionally, some of the asset properties 302 are provided to the process control module 305 after the asset is decrypted in the decryption and key management module 320. The process control module controls 305 each process by regulating the transfer of asset data between each process module based on a frame period and providing the configuration data to each module for both the current frame of asset data and the next frame of asset data. Thus, the process control module 305 regulates the flow of asset data and multiple dissimilar assets can be processed through the pipeline at the same time. For example, the last frame of Asset A may be processed in the entropy decoder 321 while the first frame of asset B is processed in the stream parsing module 322. In such a situation, the process control module 305 would provide the configuration data for asset A and asset B to the entropy decoder 321 , so that when the final frame of data from asset A is finished, the entropy decoder 321 can immediately begin processing the first frame of asset B using the configuration data for asset B.

The video processing system embodiment of FIG. 3 includes a plurality of processing modules. It should be understood that the system of FIG. 3 is an exemplary system and that in practice multiple pipelined processing modules may be configured in parallel with a central process control module. For example, there may be 16 parallel pipelines that fan out from a single data input in order to accommodate high resolution imagery such as motion pictures in a 4K format. The processing modules may be software, hardware or a combination of software and hardware. In one embodiment, the processing modules are different circuits that are each part of a single integrated circuit. The video processing system as shown includes a decryption module 320 for decrypting the encrypted video asset data. The video processing system may be used with feature films and the data for the feature films would ordinarily be encrypted. The decryption module 320 receives the decryption key from a key manager 319. The keys for the decryption process are not provided with the asset in order to maintain security and the key manager 319 monitors the assets and provides the proper key for the asset. Once the asset is decrypted the digital data is provided to a stream parser 322. The stream parser 322 allows the data to be parsed according to some criteria. For example, the stream of digital data may be parsed based upon each frame, field or sub-band of a field. The stream parsing module can then provides the data to one or more entropy decoders 321. The asset data can be decompressed in parallel such that there may be a plurality of entropy decoders 321, dequantizers 323 and inverse transform modules 324 that each process separate frames of data or frequency bands of frame data simultaneously. The asset data may have been processed originally by a wavelet sub-band encoding technique and thus, each frame of video data may include a plurality of frequency sub-bands. Once the data is decompressed, the data is re-assembled in a buffer 325. The asset data is corrected into an appropriate color space in a color space module 326. Color correction may be provided to color correct the asset data so as to conform to the color space of the display device/projector 340. The video asset data is then reframed into the appropriate geometry and aspect ratio for the display device/projector in a framing module 327. A water mark can be placed on the data by the watermarking module 328. The asset data is then re-encrypted in a format that can be decrypted by the display device/projector in an encryption module 329. The asset data is then directed to the physical module 330, which conforms the data to the link standard. For example, the data may be transmitted digitally on an optical cable, the data may be sent over a digital cable, or the data may be transmitted wirelessly. During the processing, the process control module 305 causes the data to be forwarded through the pipeline at the frame rate for the assets. Thus, each module operates substantially at or above the frame rate. Modules that operate in parallel can operate on portions of a frame of data at the frame rate. Thus, as previously mentioned, multiple sub-bands for a frame can be processed in parallel through multiple processing modules, wherein at least one complete frame is processed through the parallel entropy decoders 321, dequantizers 323, or inverse transform modules 324 during a frame period.

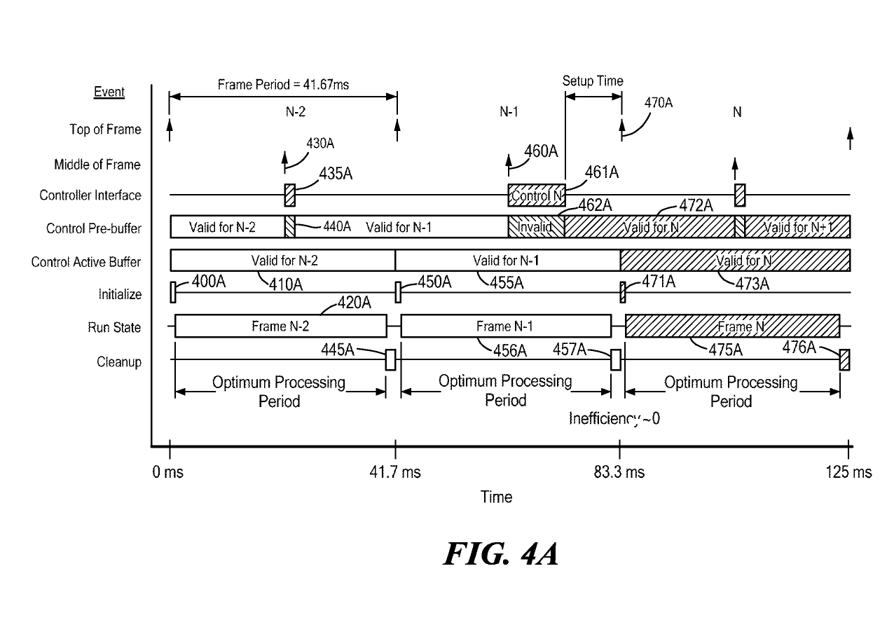

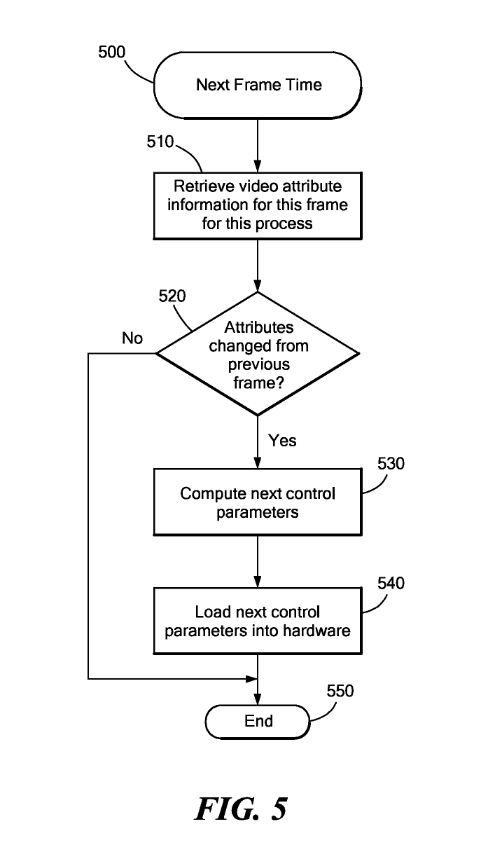

FIG. 4 is a block diagram of a typical processing module 400 from FIG. 3. The processing module is controlled by a process control module, such as the central process control module shown in FIG. 3. In other embodiments, process control may be external to the processing pipeline wherein both data and configuration information for each of the processing modules are pipelined between processing modules. The process control module can indicate if a processing module should be included within the pipeline. Thus, the processing module may be operational in the system or non-operational. If the processing module is non-operational, the data 405 will bypass 410 the processing block 420 and will be passed to the next processing module. For example, if the video asset is not encrypted, the decryption module would be non-operational in the pipeline and the video asset data would be forwarded to the stream parsing module as shown in the embodiment of FIG. 3. It should be noted that FIG. 3 is provided for exemplary purposes and should not be seen as a limiting embodiment. The video processing system described herein may have any number and type of pipelined processing modules.

Each processing module receives a frame timing signal 430 from a timing module (e.g. the process control module or a separate timing circuit) and also receives at a data input 404 current frame data 405 for a video asset at the top of frame for a frame period. Each processing module includes registers or associated memory capable of holding configuration information for the current frame 430 of data being processed and also the configuration information for the next frame 440 of data to be processed. The configuration information includes operating parameters for the particular processing block and particular video asset. Since each processing module performs a different function, the configuration information for the entropy decoder module and the configuration information for the dequantizer module will be different even though the two modules are processing the same video asset. When assets change, for example, when an advertisement finishes and a movie begins, the configuration information for a processing module will be different for the current frame and the next frame if the two assets have different asset properties (size, encoding, frame ratio etc.). Thus, the processing block 420 can switch between the register for the current video frame 430 for a first video asset and the next video frame 440 for a second video asset and the processing module may be reconfigured at the top of frame for each processing module in the system without needing to be updated at the top of frame by the process control module. The updating of the next frame configuration register 440 for a processing module 400 may be performed during the frame time before the changes should take effect (typically at the midpoint of the time allotted to the preceding frame). In certain embodiments, the central process control module may calculate the operating parameters for a processing module based upon the properties of the video asset being processed. In other embodiments, the video asset properties are provided to the processing block 420 for the next frame of video and while the current frame of video is being processed. The processing block 420 can use inactive control registers, which are designed specifically for the purpose of staging configuration data in a way that does not disturb the active control registers. The operating parameters are then stored to the configuration register for the next frame 440 while the current frame is still being processed. When a timing signal 430 is received by the processing module 400 indicating the beginning of a new frame period (top of frame), the processing module either passes the operating parameters from the next frame configuration register 440 to the current frame configuration register 430 or switches pointers and makes the next frame configuration register the current frame configuration register and uses those operating parameters on the newly received video frame data.

By having an additional register or series of registers for the next frame configuration within each processing module of a microprocessor-bus controlled video pipelined process system, microprocessor service latency of the process control module is reduced, so that the processing modules can operate in real-time when switching between configurations for video assets. Since the system operates in real-time, each processing module must receive both frame data and also initialize the processing module with the configuration data at the top of a frame period. Using standard interrupt mechanisms wherein both data and configuration information are provided at the same time (e.g. top of frame) by a process control module, latency to a given module may be both slow and unpredictable. In a system, such as the contemplated video processing system, there are a number of processing modules and there may be multiple parallel pipelined processing modules. Thus, a small delay in providing configuration information to the processing modules can become fatal in a real-time video processing system where a frame must be output for each frame period. In such a real-time video processing system, each processing module must comply with the temporal input/output requirement. By creating a pre-load of the next frame configuration data in a separate register, wherein the data is provided to the processing module ahead of the top of frame, and therefore there is a zero-delay between the switch in configuration data, all of the processing modules can switch in phase at the top of frame and be synchronized.

The process control module handles both middle of frame and top of frame updates. The middle of frame interrupts provide the next frame configuration data to the idle next frame configuration register 440 for the processing module. It should be understood that the process control module may update the processing modules at one or more times within a frame period without deviating from the scope of the invention, wherein the top of frame is preferable for initialization and data transfer between modules and the middle of frame is preferred for providing the next frame configuration data to a processing module. The middle of frame timing signal is approximately 180 degrees out of phase with the top of frame timing signal (although the middle of frame could be at any point during a frame period other than the top of frame). In such a configuration, the middle of frame updates do not impact the processing block 420 during that frame period and the middle of frame updates (next frame configuration information) are latched over at the top of frame for the next frame period and used as the configuration for the process module.

FIG. 4A shows a detailed timing diagram for the operation between the process control module and a typical processing module during a frame period. As shown in the figure two video assets are processed back-to-back. Video asset 1 is processed during periods N−2 and N−1 and video asset 2 is processed during frame period N. During frame period N−2, configuration data is first initialized 400A for processing the current frame N−2. The processing module access the current frame configuration register 410A and frame N−2 is processed 420A for the majority of the frame period. At the middle of frame (which is out of phase with the top of frame timing signal) 430A, the process control module is active 435A and communicates with the process module. During this time period, the next frame configuration register is invalid 440A, since the register's configuration data is swapped out with the configuration data for frame N−1. Since the video asset is the same between the first and second frame period (N−2 and N−1), the invalid period is short. After frame N−2 is processed the processing module performs clean-up 445A. At the top of the next frame period, initialization of the processing module occurs 450A. The processing module also switches configuration registers and accesses the configuration information for frame N−1 in the current frame configuration register 455A. Frame N−1 is processed by the processing module 456A and when the processing is complete cleanup occurs 457A before the next top of frame. At the middle of frame 460A, the control module 461A makes the next frame configuration register invalid 462A and updates the register with the configuration data for video asset 2 as designated by N. This invalid period 462A is greater because more data must be swapped out, since a changeover in video assets will occur at the next top of frame. At the next top of frame for frame period N 470A, again initialization occurs 471A and the processing module switches data between the next frame configuration register 472A and the current frame configuration register 473A and uses the configuration data. The process module processes frame N 475A and when the processing module finishes cleanup 476A of the processing module occurs. During the middle of frame, the next frame configuration becomes inactive and the register is updated with the configuration data for the next frame N+1. This process continues until all of the assets are processed. It should be noted that the current frame configuration register is always valid for the processing module to use. This allows the processing module to operate seamlessly from frame-to-frame except during initialization and clean-up.

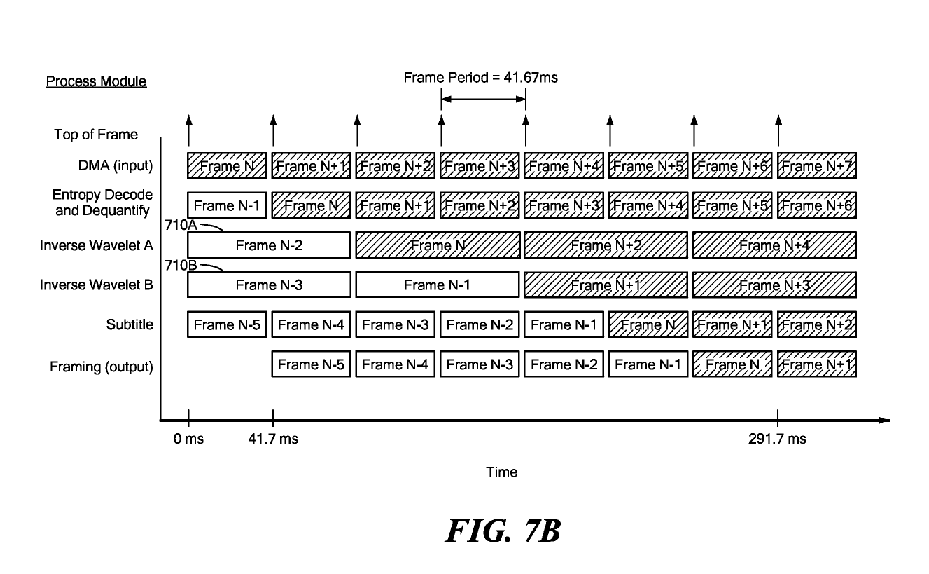

In FIG. 3, some processing modules operate in discrete “frame periods” equivalent to the eventual output frame rate. In the embodiment as shown in FIG. 3, the decryption module and all others downstream operate in this manner. Other parts of the chain are asynchronous to the frame rate, and at times run faster or slower than the frame rate. The blocks that fetch the material from disk (“Asset” module) and the subsequent “Buffer” module operate in this manner. Timing diagrams and an example system are discussed below with respect to FIGS. 7A and 7B.

As indicated above, the video processing system allows for video assets having different asset properties to be processed in real-time and conformed to the format for the display device. If an asset needs to be resolved to a lower resolution from that of its native resolution for display on the display device, for example 4K to 2K extraction, wherein the video asset has been compressed using a sub-band encoder (e.g. a wavelet compression the higher frequency sub-bands can be discarded and the lower-frequency sub-bands are used. 4K content is 4 times the size of 2K content. As shown below, the highest transform band, the “L” sub-band is decoded normally but the H, V, and D sub-bands are discarded. Thus, only ¼th of the information is forwarded through the digital video processing system.

| | |
|---|---|
| L | H |
| | Discard |
| V | D |
| Discard | Discard |

The following processing modules are involved with 2K-4K and 4K-2K scaling and extraction of sub-band encoded asset data (e.g. JPEG2000): Stream Parsing Module, Entropy Decoding Module, DeQuantization Module, and Inverse Transform Module.

If 2K to 4K upscaling is desired, additional transform bands are inserted into the 2K data wherein the 2K data forms the “L” sub-band for the 4K data and the H, V, and D sub-bands are synthesized. These values can be synthesized by interpolating data points or by other techniques known to those of ordinary skill in the art. In such a system, the video processing system would include parallel processing modules for processing the additional data through the system including parallel modules for entropy decoding, dequantization, and inverse transform coding.

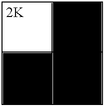

The following processing modules are involved with real-time geometry size processing: Stream Parsing Module, Entropy Decode Module, DeQuantization Module, Inverse Transform Module, Buffer & Position Module and the Framing module.

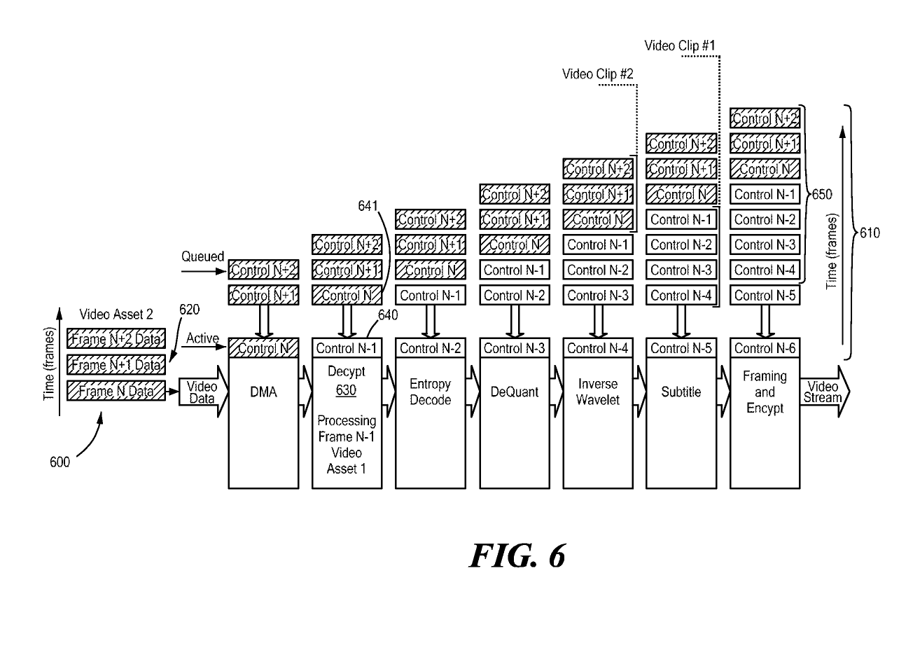

FIG. 5 shows a flow chart explaining an alternative embodiment for updating the current frame and next frame configuration registers. First, a middle of frame timing signal is received by the pipelined processing module 500. The processing module retrieves configuration information for a next frame of a video asset from a control pipeline held by the process control module 510. The processing module checks to see if the video attributes for the video asset have changed from the current frame 520. In this embodiment, if the video attributes have not changed no updating is necessary to the configuration registers for the processing module and the next frame register is not used 550. This optimization assumes that the processing module can keep its operating parameters from a previous time frame. If this is the case, this process serves to cut down on unnecessary hardware set-up during periods of unchanged processing (i.e. the video asset is the same over multiple frames). If the processing module can not maintain the operating parameters, the processing module will always update the next frame configuration register as explained above. If the video attributes have changed, which indicates a change in the video asset, the process control module will compute the new operating parameters for the new video asset 540. It should be clear that these operating parameters are to be used for processing the frame data that flows into the processing block during the next frame time. The process control module will then update the next frame configuration register for the processing module with the determined processing parameters 540.

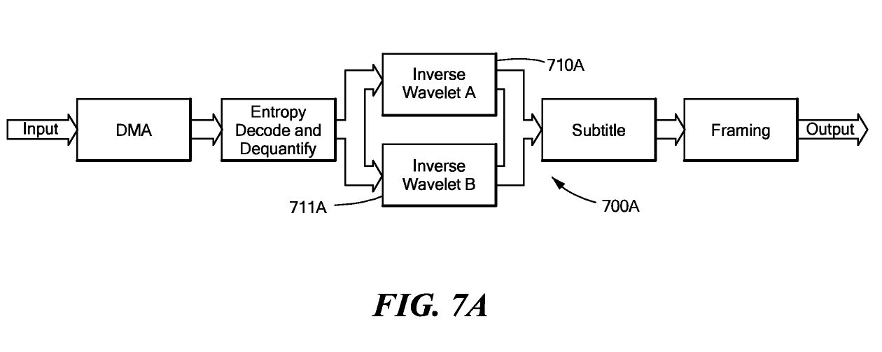

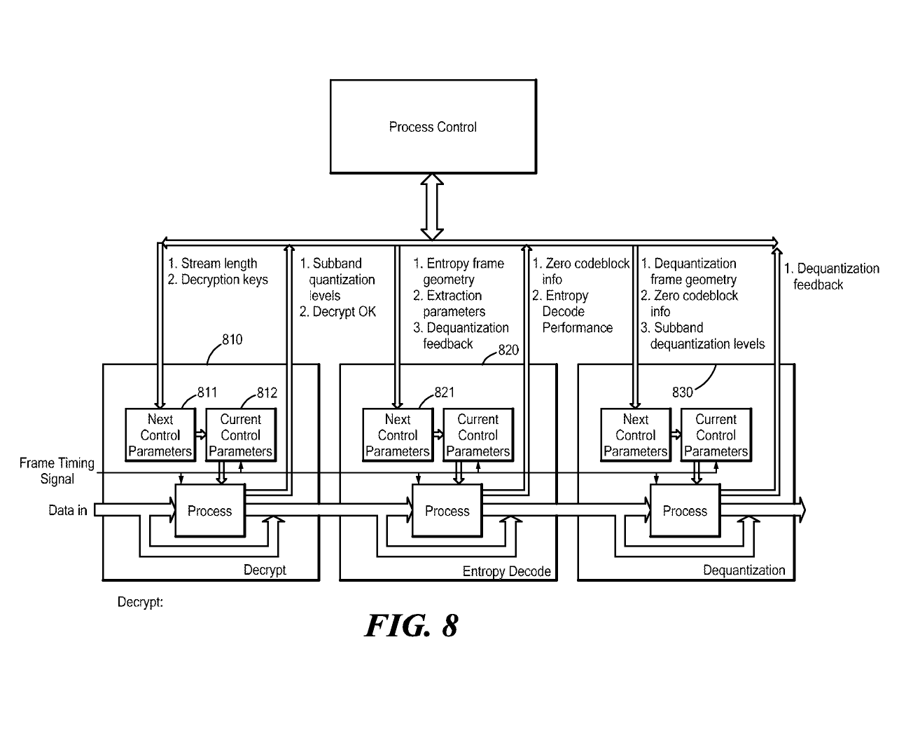

FIG. 6 is a timing diagram that shows the progression of both the encoded frame data 600 through the video processing system and the progression of the configuration information/operating parameters 610 for each of the modules. In this figure multiple video assets are queued for seamless playback. The video assets would be queued by the playlist processor of FIG. 3. Compressed video data of a video asset is input to the system in units of frames, on a per frame period (i.e. 41 ms for a 24 Hz system). The compressed data is read from a storage location, such as a hard drive or optical disk. A specific video processing algorithm is performed in a pipelined manner over a number of frame periods through the pipelined processing modules for each unit of data. A different video processing configuration may be applied to each unit of data (e.g. frame data) for a video asset. For example, as contemplated in FIG. 8, parameters determined in a first processing module based upon the processed data may be used in a subsequent processing module to process that same data. Each stage of the pipeline (processing module) performs an entirely separate process, but each process is part of the same overall algorithm for the system.

When a data unit, such as a frame 620, is input to the system, the process control module assigns a specific set of operating parameters to the data unit. The operating parameters advance in time along with the frame data as it moves through each of the processing modules. Thus, the operating parameter queuing operates synchronously with the data queue and both queues operate synchronously with a frame period.

As shown in FIG. 6, N is normalized to the data as it enters the system. Frame N 620 represents the first frame of a new video asset (video asset 2) whereas all preceding frames in the pipelined modules (N−1, N−2, N−3 etc.) represent a first video asset (video asset 1). The shadowed elements reference video asset 2 while the non-shadowed elements reference video asset 1. As each frame period changes, the video data advances to the next processing module in the pipelined system and the operating parameters are also advanced to the processing module. For example, the process control module calculates and queues all of the operating parameters for the decryption module 630. As shown, the decryption module 630 is currently processing Frame N−1 of the first video asset using the operating parameters Control N−1 640. The Control N−1 operating parameters 640 are stored in the register for the current frame configuration and the Control N operating parameters are queued in the decryption module's next frame configuration register 641. The process control module calculates the operating parameters for each of the frames of the video assets and stores them in queue 650. As the next frame period occurs the decryption module will replace the operating parameters Control N-I with the operating parameters Control N as frame N enters the decryption module. Therefore, as the video assets transition between video asset 1 and video asset 2, the processing modules transition between configuration information seamlessly.

FIGS. 7A and 7B show a different processing pipeline and corresponding timing diagram from that shown in FIG. 6. This video pipelined processing system includes parallel processing modules 710A and 711A. The same control principles applied with respect to previously described embodiments also apply with respect to the embodiment as shown. The timing diagram shows that the parallel modules 710A and 711A for performing an inverse wavelet transform operate over more than one frame period (as shown two frame periods), but achieve the same outcome, wherein two frames are processed over two periods. At the top of frame at 0 ms the DMA processing module processes frame N of video asset 2, while entropy decode and dequantify module operates on frame N−1 of video asset 1, inverse wavelet module A operates for two periods on frame N−2 and inverse wavelet module B operates for two periods on frame N−3. Even though the output of the inverse wavelet modules operate over two frame periods, the output of the system is a sequence of video frames wherein each frame is output at the display device frame rate.

FIG. 8 shows an example of a plurality of pipelined processing stages wherein the current processing module feeds forward configuration information to the next processing module during the processing frame period. The process of feed forwarding of information, adds additional complexity to the video processing system. As shown, a decryption module 810 is followed by an entropy decoding module 820, which is followed by a dequantization module 830. Configuration information is forwarded to the decryption module including the operating parameters that indicate the length of the stream for a video asset and the decryption keys. This information is provided to the configuration register for the next frame of video 811. At the top of frame, the operating parameters are transferred to the register for the configuration information for the current frame 812. During this frame period, the current frame of video date is processed by the decryption module using the stream length and decryption keys operating parameters. The decryption processing module 810 reads the decrypted data, checks to confirm that the data has been properly decrypted and stores the date into a buffer during the frame period. Header information is retrieved from the decrypted data and passed through to the entropy decoder module during the same frame period. The header information includes the sub-band quantization levels. The entropy decoder 820 is also provided with an indication whether the decryption was properly performed. Thus, the entropy decoder 820 uses the sub-band quantization levels to determine the entropy decoder's configuration. The sub-band quantization levels may be fed forward more than one module. These configuration parameters include the entropy frame geometry (e.g. 4096×2160 pixels), the extraction parameters (e.g. 2K extraction from a 4K frame) and the dequantization feedback (feedback from the dequantization module which may include video metrics and shared zero codeblock information) are stored in the next frame configuration register 821. Similar processes occur for the dequantization module. In such a configuration, there is a localized process control between one or more processing modules, so that the processing modules may communicate without effecting communications over the microprocessor bus between the centralized process control and each of the processing modules. Thus, process control operates in a hierarchical manner wherein the centralized process control module controls top of frame transitions and updates the configuration registers based upon global system information and the localized process control feeds forward information to subsequent processing modules for determining configuration data based on the information.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form. The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device ( e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL, Verilog or AHDL), or a PLD programming language (e.g., PALASM, ABEL, or CUPL.)

The present invention may be embodied in other specific forms without departing from the true scope of the invention. The described embodiments are to be considered in all respects only as illustrative and not restrictive.

We claim:

1. A modular video processing system capable of processing a plurality of video assets having different asset properties in substantially real-time to a format compatible with a display device, the system comprising:
a plurality of pipelined video processing modules wherein each operational pipelined video processing module performs a different configurable video processing function on one or more video asset frames; and
a process control module for providing each operational pipelined video processing module with data for configuring the video processing module for a current frame and data for configuring the video processing module for a subsequent frame wherein each configuration is based on one or more asset properties for the video asset being processed.

2. The modular video processing system according to claim 1 wherein each pipelined video processing module has a memory location for the configuration for the current frame and a memory location for the configuration for a subsequent frame and the pipelined video processor switches between the memory location for the configuration for the current frame and the memory location for the subsequent frame based on a timing signal.

3. A modular video processing system according to claim 1 wherein the process control module calculates one or more operating parameters of the configuration based on the one or more asset properties of the video asset.

4. A modular video processing system according to claim 1, wherein after a first pipelined video processing module processes data for the current frame of a video asset, the first pipelined video processing module passes the processed data to a second pipelined video processing module based on a timing signal.

5. A modular video processing system according to claim 1, wherein the process control module is a central controlling module for two or more video processing modules.

6. A modular video processing system according to claim 1 wherein the process control module pipelines one or more asset properties for each video asset through each of the operational video processing modules.

7. A modular video processing system according to claim 1, wherein the process control module is a centralized control module, the centralized control module processing for each operational pipelined video processing module asset parameters for each video asset defining a configuration for that video asset for the operational pipelined video processing module and wherein the centralized control module provides the configuration to the appropriate operational pipelined video processing module based on the video asset being processed.

8. A modular video processing system according to claim 1, wherein one or more pipelined processing modules receive a current frame for processing from a previous pipelined processing module at a top of frame period.

9. A modular video processing system according to claim 1, wherein a pipelined video processing module may by operational or idle.

10. A modular video processing system according to claim 9, wherein if a processing module is idle, the process control module does not provide that pipelined video processing module with configuration data.

11. A modular video processing system according to claim 1, wherein the pipelined video processing modules outputs processed data to a display device at a frame period rate.

12. A modular video processing system according to claim 1, wherein each processing module can be reconfigured in real-time when frame processing periods change, since a configuration for the subsequent frame is already stored in associated memory of the pipelined video processing module.

13. A modular video processing system according to claim 1, wherein each pipelined video processing modules receive a repeating frame timing signal and data processed for the current frame in a first pipelined video processing module is forwarded to a second video processing module when the frame timing signal repeats.

14. A modular video processing system according to claim 1, wherein the pipelined processing modules decompresses each frame of a video asset.

15. A modular video processing system according to claim 1 wherein the plurality of pipelined video processing modules includes an entropy decoder module, a dequantizer module, and an inverse transform module.

16. A modular video processing system according to claim 1, wherein the process control module is localized to two or more processing modules and the system further includes a centralized processing control module that communicates with each of the process control modules over a bus.

17. A modular video processing system according to claim 1, wherein data determined by a first processing module is fed forward to a subsequent processing module for determining operating parameters for configuration of the subsequent processing module.

18. A method for processing a plurality of video assets having different asset properties in substantially real-time to a format compatible with a display device, the method comprising:
obtaining a play list of the plurality of video assets to be displayed on a display device;
sequentially retrieving each video asset listed in the play list from a memory location;
processing each video asset to a format that is compatible with the display device; and
output the processed sequential video assets to the display device;
wherein each video asset is processed and displayed in substantially real-time.
